(19) United States
(12) Patent Application Publication
(10) Pub. No.: US 2024/0264923 A1
(43) Pub. Date: Aug. 8, 2024

(54) IDENTIFYING UNKNOWN PATTERNS IN TELEMETRY LOG DATA

(71) Applicant: Dell Products L.P., Round Rock, TX (US)

(72) Inventors: Benjamin Fauber, Austin, TX (US); Lee Saeugling, Austin, TX (US); Joseph Tansey, Tampa, FL (US)

(21) Appl. No.: 18/166,243

(22) Filed: Feb. 8, 2023

(51) Int. Cl. G06F 11/34; G06F 11/07

(52) U.S. Cl. CPC G06F 11/3476; G06F 11/0793

(57) ABSTRACT

A system can receive a group of computer log entries that comprise letters in an alphabet. The system can convert log entries of the group of computer log entries into respective first vectors that comprise numerical values. The system can perform a first similarity search with respect to the first vectors to identify respective groups of vectors that identify a same known computer issue. The system can perform machine learning on the respective groups of vectors to identify signatures of known computer issues. The system can perform a second similarity search with respect to second vectors and third vectors that correspond to the signatures of known computer issues to identify devices that correspond to the second vectors that have at least one known computer issue of the signatures of known computer issues. The system can store an indication of the devices.

### BACKGROUND

Telemetry can generally comprise a process of recording and transmitting the readings of an instrument. Telemetry data can be data generated during telemetry. Telemetry log data can provide information on the operating status of a computer.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a group of computer log entries that comprise letters in an alphabet. The system can convert log entries of the group of computer log entries into respective first vectors that comprise numerical values. The system can perform a first similarity search with respect to the first vectors to identify respective groups of vectors that identify a same known computer issue. The system can perform machine learning on the respective groups of vectors to identify signatures of known computer issues. The system can perform a second similarity search with respect to second vectors and third vectors that correspond to the signatures of known computer issues to identify devices that correspond to the second vectors that have at least one known computer issue of the signatures of known computer issues. The system can store an indication of the devices.

An example method can comprise converting, by a system comprising a processor, log entries of a group of device log entries into respective first vectors that comprise numerical values, wherein the group of device log entries comprises text drawn from an alphabet. The method can further comprise performing, by the system, a first similarity search with respect to the first vectors to identify respective groups of vectors that identify a same known device issue. The method can further comprise performing, by the system, machine learning on the respective groups of vectors to identify signatures of known device issues. The method can further comprise performing, by the system, a second similarity search with respect to second vectors and third vectors that correspond to the signatures of known device issues to identify devices that correspond to the second vectors that have at least one known device issue of the signatures of known device issues.

An example non-transitory computer-readable medium can comprise instructions that, in response to execution, cause a system comprising a processor to perform operations. These operations can comprise converting log entries of a group of computer log entries into respective first vectors that comprise numerical values. These operations can further comprise performing a first similarity search on the first vectors to identify respective groups of vectors that identify a same known computer issue. These operations can further comprise performing machine learning on the respective groups of vectors to identify signatures of known computer issues. These operations can further comprise performing a second similarity search on second vectors and third vectors that correspond to the signatures of known computer issues to identify devices that correspond to the second vectors.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate identifying unknown patterns in telemetry log data, in accordance with an embodiment of this disclosure;

FIG. 2 illustrates another example system architecture that can facilitate identifying unknown patterns in telemetry log data, in accordance with an embodiment of this disclosure;

FIG. 3 illustrates an example process flow that can facilitate identifying unknown patterns in telemetry log data, in accordance with an embodiment of this disclosure;

FIG. 4 illustrates another example process flow that can facilitate identifying unknown patterns in telemetry log data, in accordance with an embodiment of this disclosure;

FIG. 5 illustrates example graphs that can facilitate identifying unknown patterns in telemetry log data, in accordance with an embodiment of this disclosure;

FIG. 6 illustrates an example graph that can facilitate identifying unknown patterns in telemetry log data, in accordance with an embodiment of this disclosure;

FIG. 7 illustrates an example table that can facilitate identifying unknown patterns in telemetry log data, in accordance with an embodiment of this disclosure;

FIG. 8 illustrates another example process flow that can facilitate identifying unknown patterns in telemetry log data, in accordance with an embodiment of this disclosure;

FIG. 9 illustrates another example process flow that can facilitate identifying unknown patterns in telemetry log data, in accordance with an embodiment of this disclosure;

FIG. 10 illustrates another example process flow that can facilitate identifying unknown patterns in telemetry log data, in accordance with an embodiment of this disclosure;

FIG. 11 illustrates another example process flow that can facilitate identifying unknown patterns in telemetry log data, in accordance with an embodiment of this disclosure;

FIG. 14 illustrates another example process flow that can facilitate identifying unknown patterns in telemetry log data, in accordance with an embodiment of this disclosure;

FIG. 13 illustrates another example process flow that can facilitate identifying unknown patterns in telemetry log data, in accordance with an embodiment of this disclosure;

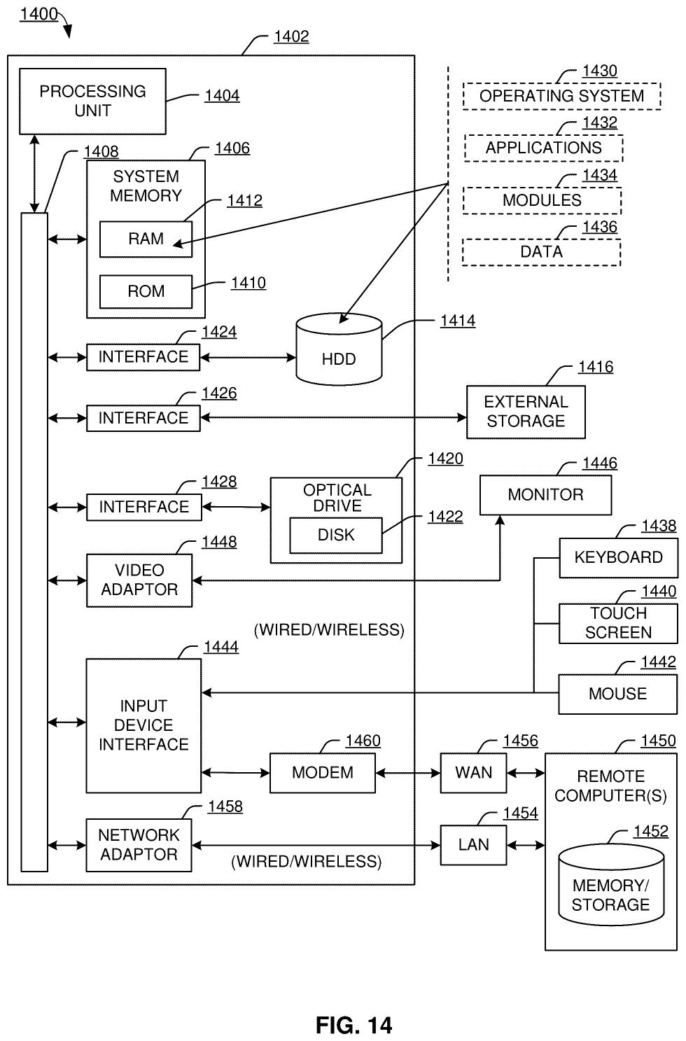

FIG. 14 illustrates an example block diagram of a computer operable to execute an embodiment of this disclosure.

### DETAILED DESCRIPTION

### OVERVIEW

Exploiting information stored in event logs and telemetry data can be an evolving area of process mining research, with applications in process discovery and process enhancement. Telemetry data can be instrumental in an ability to detect anomalies in hardware, and proactively support customers who use the hardware.

Some approaches can use telemetry data to remediate hardware issues before they cause problems for customers. These approaches can involve identifying unique fingerprints in telemetry data that is tied to a finite set of issues and remediating those issues with known solutions.

The present techniques can be implemented to identify unique fingerprints telemetry log data that are tied to known issues. The present techniques can be scalable and agnostic to the hardware and level-of-business (LOB).

High-frequency telemetry data can be instrumental in an ability to detect anomalies in hardware, and proactively support customers.

The present techniques can be implemented to facilitate accurate identification of telemetry log file signatures for the most common issues with high precision (e.g., positive predictive value. This can be a fraction of retrieved documents that are relevant to the query) and recall (e.g., sensitivity. This can be a fraction of the relevant documents that are successfully retrieved). Further, the present techniques can be implemented to provide an additional benefit in identifying telemetry log file fingerprints, and the most relevant data sources, to power other telemetry log machine learning projects.

Telemetry data can be batched or bundled into timestamped readings, which can then be bundled into documents (such as documents in a JavaScript Object Notation (JSON) format). In some examples, telemetry data delivery intervals can be a short as every minute (e.g., for data that is collected every 1-5 seconds and transferred internally from internal data centers) to as infrequent as every 3 weeks (e.g., for data collected daily from external hardware).

On-premises data collectors (that is, data collectors that are located at a user's physical location) can receive many pieces of telemetry data from different hardware. The disparate data can be grouped together and transmitted to a central database. At the central database, the grouped data can be processed, and the individual timestamped metric values can be ingested into a tabular database along with relevant metadata like source identifier and metric instance info and metric group (where defined).

A problem associated with telemetry data can involve having a large amount of the data. In an example, there can be 80,000,000,000 records available in a data vault, where the data is categorized and stored in tables at a component level (e.g., separate tables for central processing unit (CPU) data, hard drive data, and memory data). Prior approaches to storing and processing telemetry data can make it challenging to understand whole-machine states over time, and how changes in attributes within a machine can impact its overall health. There can be a desire to understand whole-machine states over time in order to create next-generation telemetry data and user support offers.

Another problem associated with telemetry data can be slow performance. Prior approaches can lack an ability to understand which telemetry fingerprints are associated with slow performance. The present techniques can be implemented to directly identify key indicators of telemetry log data signatures associated with an issue. The present techniques can be applied to other issues as well. In some examples, the present techniques can be targeted at telemetry log or text files, rather than metrics or numerical values. In some examples, telemetry log files (e.g., text data) can be more challenging to mine and use in machine learning as compared to numerical values. It can be that numbers easily allow for summary statistics and numerical thresholding (e.g., if a value exceeds a threshold, then issue an alert), whereas text and strings can be more difficult to utilize in machine learning. The present techniques can be applied to this more challenging area of telemetry log/text files, and their use in identifying telemetry signatures associated with key user issues.

In some examples, the present techniques can be implemented with multiple steps: linking user issues to telemetry log data; extracting telemetry data representations and/or signatures from the log data; detecting anomalies in the telemetry time series data that are associated with the user issues; and associating the telemetry log data signatures with user issues.

The present techniques can differ from prior approaches in that they can be applied to telemetry log data. This can mean that devices configured to generate telemetry log data can be evaluated, regardless of a manufacturer of the device.

The present techniques can differ from prior approaches in that the present techniques can be used to vectorize unique log events into embeddings that can be directly usable in machine learning. Then, a similarity search can be performed to find similar vectors with the same known customer issues e.g., software fix issues, or ‘soft issues’). This step can facilitate filtering to the most meaningful telemetry log data for machine learning to support a user to remediate an issue. That is, the present techniques can be implemented to facilitate an identification of telemetry signatures associated with known user issues.

A way that the present techniques can differ from prior approaches can be that the present techniques can operate on log/text data, while also being configured to ingest heterogenous data (e.g., both text data and numerical data). This can provide a benefit where some log file data is in different local languages, such as names of applications and some associated application error logs (e.g., it can be that Chinese applications installed on a computer can appear in the Chinese language).

The following example can illustrate the present techniques. In an example, there is telemetry log data that corresponds to ˜260 devices over a 6-month period. Issues can be cleaned to align typos and combine similar topics to a single topic, where issues have been input in a free-form text field. Cleaning a “software (soft) fix issue” field can reduce a complexity of the data set by 50%.

Next, the following steps can be performed: vectorization of unique telemetry log events using a multilingual text embedding deep neural network (DNN); and a similarity search can be performed to find similar vectors with the same user issues (within +/−45 days of the issue report date), allowing to filter to the most meaningful log data to power the present techniques. An analysis of the false positive ratio for the similarity search step can reveal that certain telemetry log data files are contributing to more false positive results (e.g., basic input/output system (BIOS) logs, diagnostic performance error logs, driver logs, and operating system logs) than the application logs, application error logs, and system crash logs. False positives can be defined as vectors that meet the similarity search threshold yet contain a different known issue from the query vector.

A similarity search step can facilitate focusing on the telemetry text/log data sources with fewer false positive hits: application logs, application error logs, and system crash logs. Machine learning on those three most-meaningful telemetry log data sources can be performed to find signatures in the telemetry log data, which can facilitate establishing a ground-truth of known issues associated telemetry signatures/states. Results from machine learning model training, then application of the trained model to out-of-sample (e.g., test) data on the top-five user issues. This model can demonstrate favorable precision and recall metrics on the top-five user issues, when selecting from 1 of 25 possible customer issues in this model. The null hypothesis can be metrics values of 0.04, and so it can be concluded that the present techniques function well in this scenario.

The present techniques can further be validated in this example by performing machine learning training and out-of-sample (e.g., test) set analysis on the full set of 8 telemetry text/log data sources. When using all the telemetry log data, and not pre-filtering to the most meaningful data, it can be that there is a 0.2-0.4 basis point decrease in machine learning model performance metrics, both in recall and precision. This significant drop in performance can highlight an importance of our similarity search data filtering step to identify the most important telemetry log data sources to power the present techniques and minimize false positives.

### EXAMPLE ARCHITECTURES

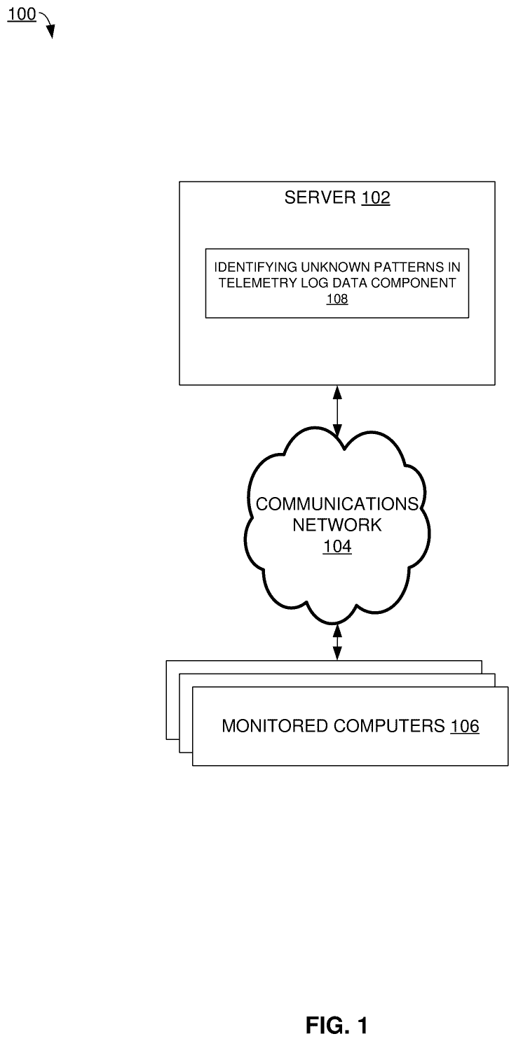

FIG. 1 illustrates an example system architecture 100 that can facilitate identifying unknown patterns in telemetry log data, in accordance with an embodiment of this disclosure.

System architecture 100 comprises server 102, communications network 104, and monitored computers 106. In turn, server 102 comprises identifying unknown patterns in telemetry log data component 108.

Each of server 102 and/or monitored computers 106 can be implemented with part(s) of computing environment 1400 of FIG. 14. Communications network 104 can comprise a computer communications network, such as the Internet.

Identifying unknown patterns in telemetry log data component 108 can receive telemetry data from monitored computers 106. via communications network 104. Identifying unknown patterns in telemetry log data component 108 can process this telemetry data to identify unknown patterns (such as identify computers that have an issue to resolve).

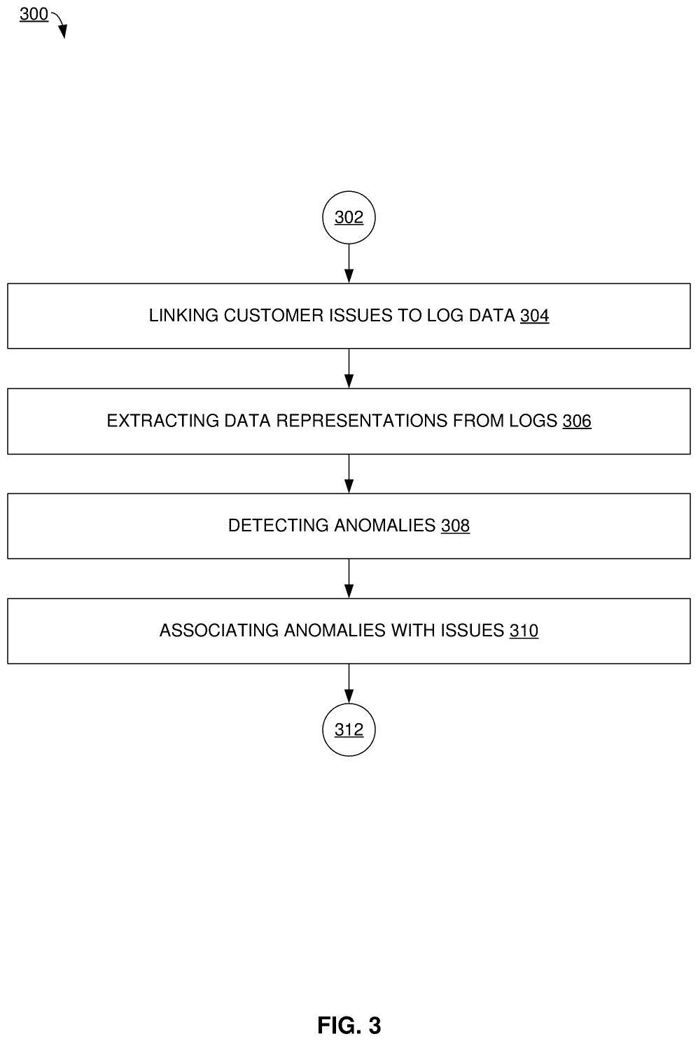

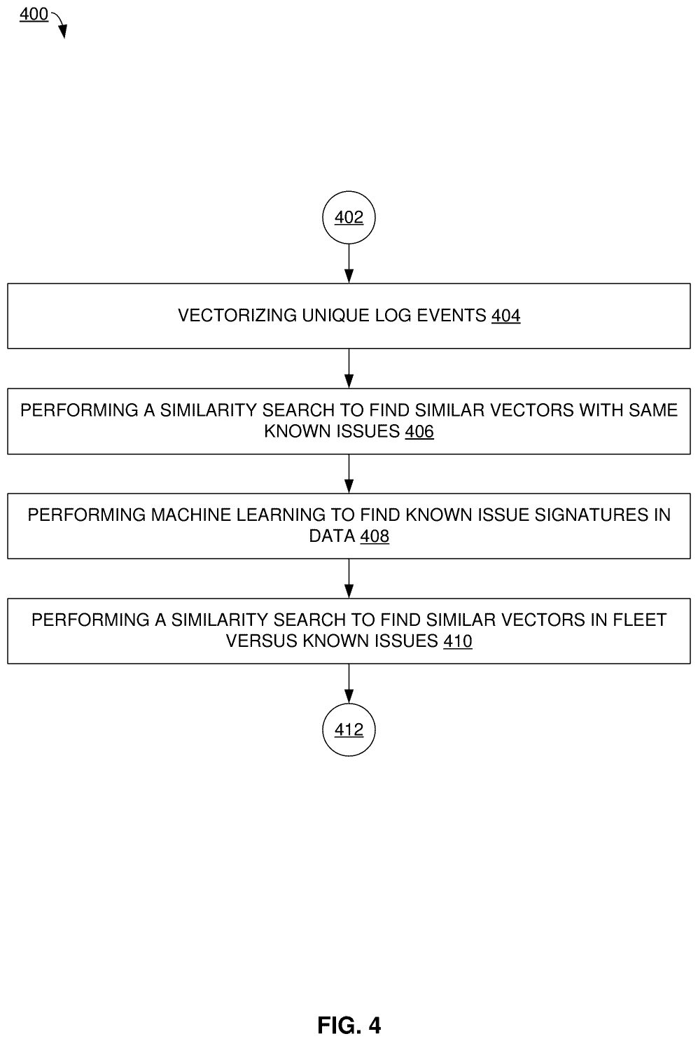

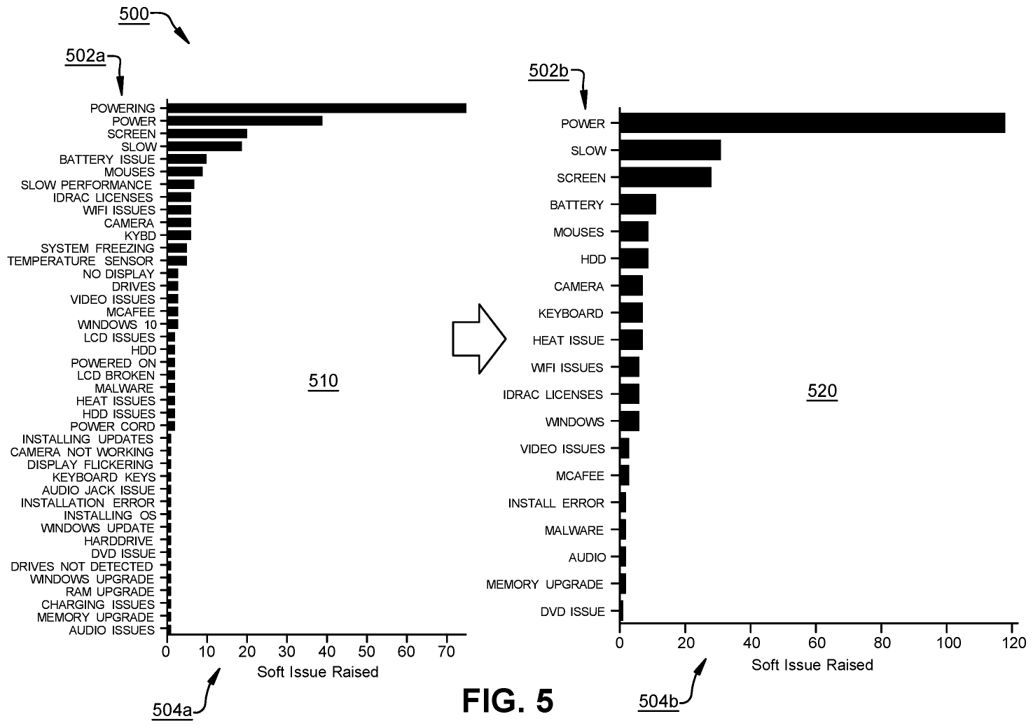

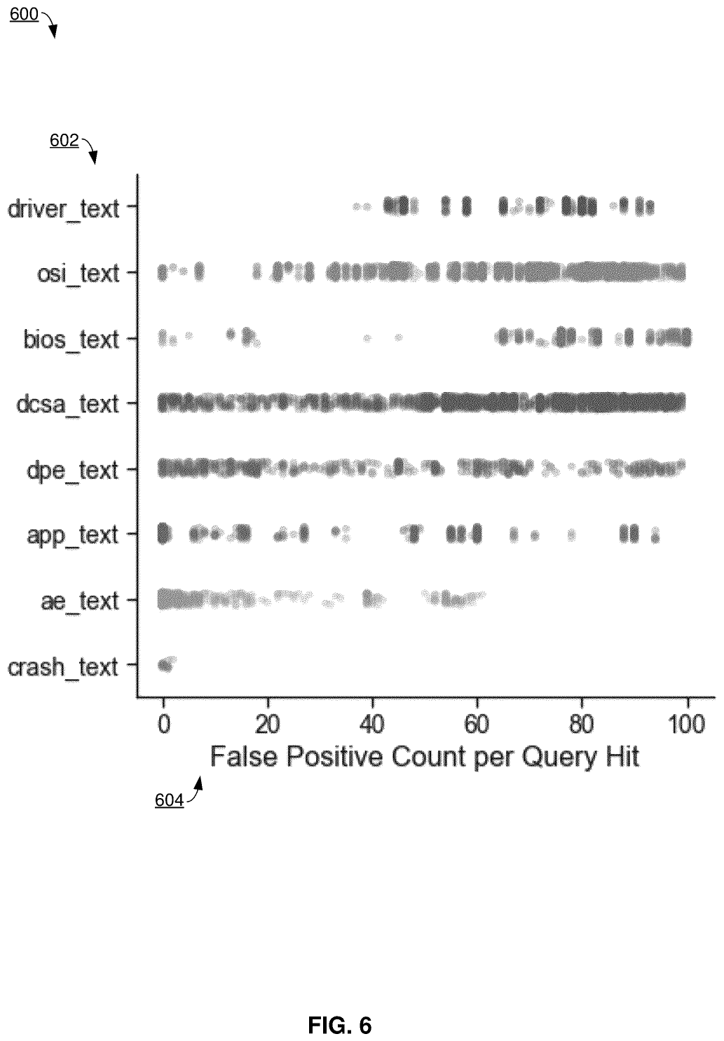

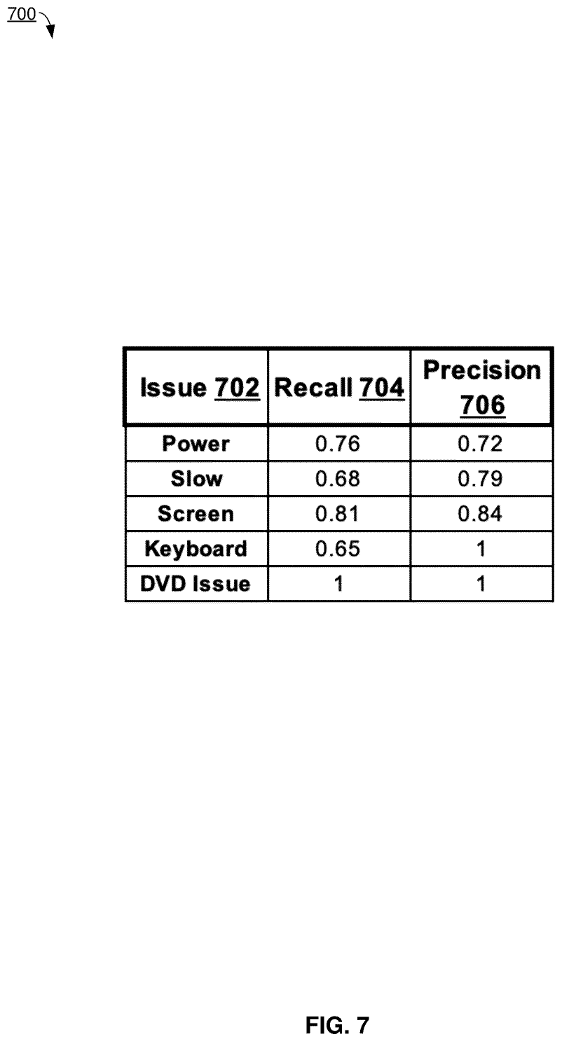

In some examples, identifying unknown patterns in telemetry log data component 108 can implement part(s) of the process flows of FIGS. 3-4 and/or 8-13 to implement identifying unknown patterns in telemetry log data. In some examples, identifying unknown patterns in telemetry log data component 108 can implement part(s) of the graphs of FIGS. 5-6 and or the table of FIG. 7 to implement identifying unknown patterns in telemetry log data.

It can be appreciated that system architecture 100 is one example system architecture for identifying unknown patterns in telemetry log data, and that there can be other system architectures that facilitate identifying unknown patterns in telemetry log data.

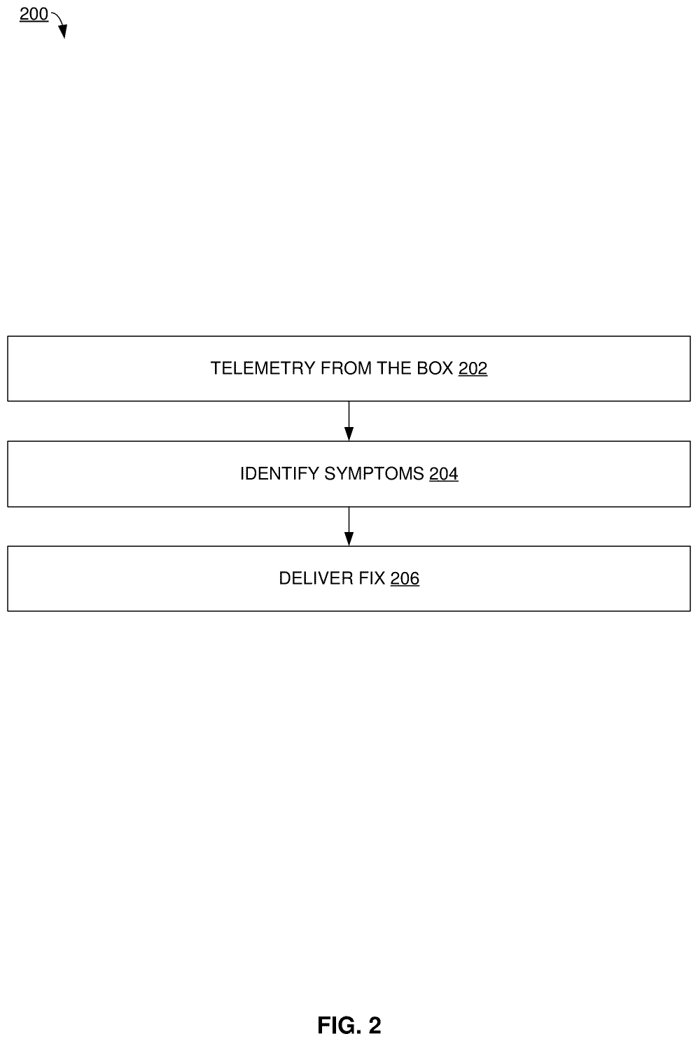

FIG. 2 illustrates another example system architecture 200 that can facilitate identifying unknown patterns in telemetry log data, in accordance with an embodiment of this disclosure. In some examples, part(s) of system architecture 200 can be used to implement part(s) of system architecture 100 of FIG. 1.

System architecture 200 comprises telemetry from the box 202, identify symptoms 204, and deliver fix 206. Telemetry data from the box 202 can comprise metrics and/or logs received from one or more of monitored computers 106 of FIG. 1. Identify symptoms 204 can comprise processing telemetry data from the box 202 to identify an issue with one or more of the monitored computers. That is, identify symptoms can comprise analyzing telemetry logs from machines to automatically and proactively identify telemetry file signatures associated with certain symptoms. Deliver fix 206 can comprise performing a remedial action on a computer for which symptoms have been identified, such as by sending a software patch to the computer via communications network 104 of FIG. 1.

### EXAMPLE PROCESS FLOWS

FIG. 3 illustrates an example process flow 300 that can facilitate identifying unknown patterns in telemetry log data, in accordance with an embodiment of this disclosure. In some examples, one or more embodiments of process flow 300 can be implemented by identifying unknown patterns in telemetry log data component 108 of FIG. 1, or computing environment 1400 of FIG. 14.

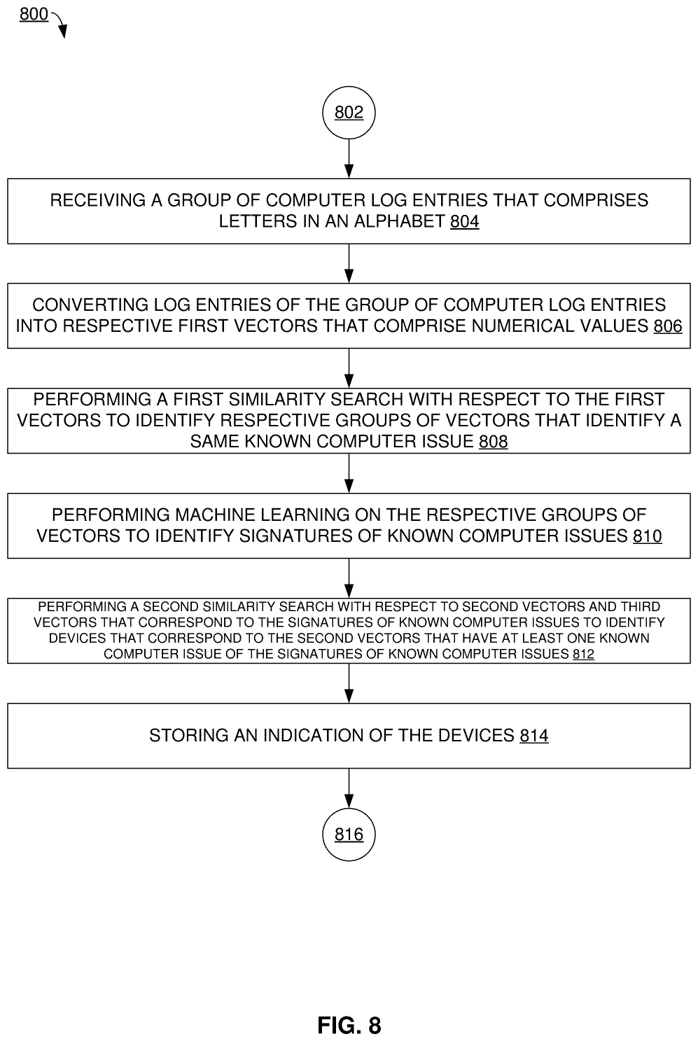

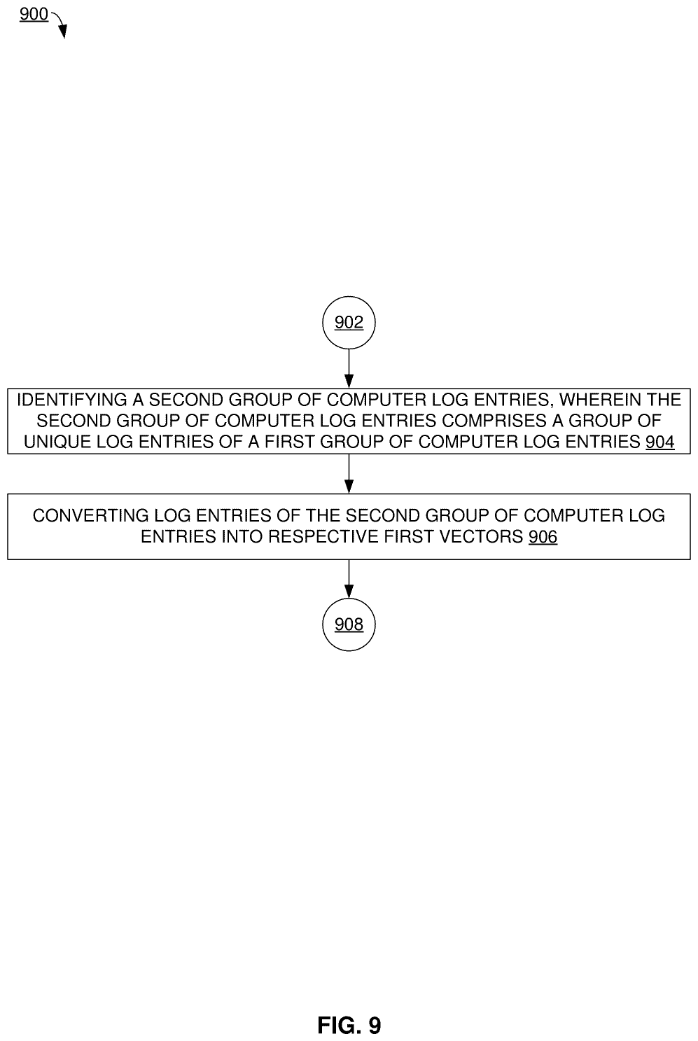

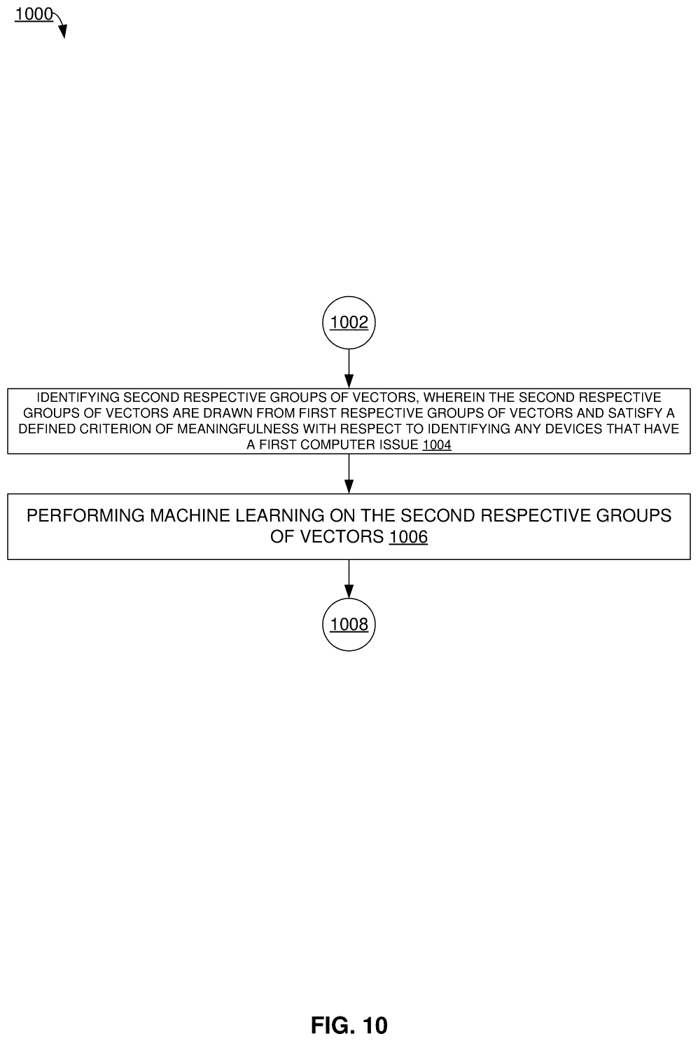

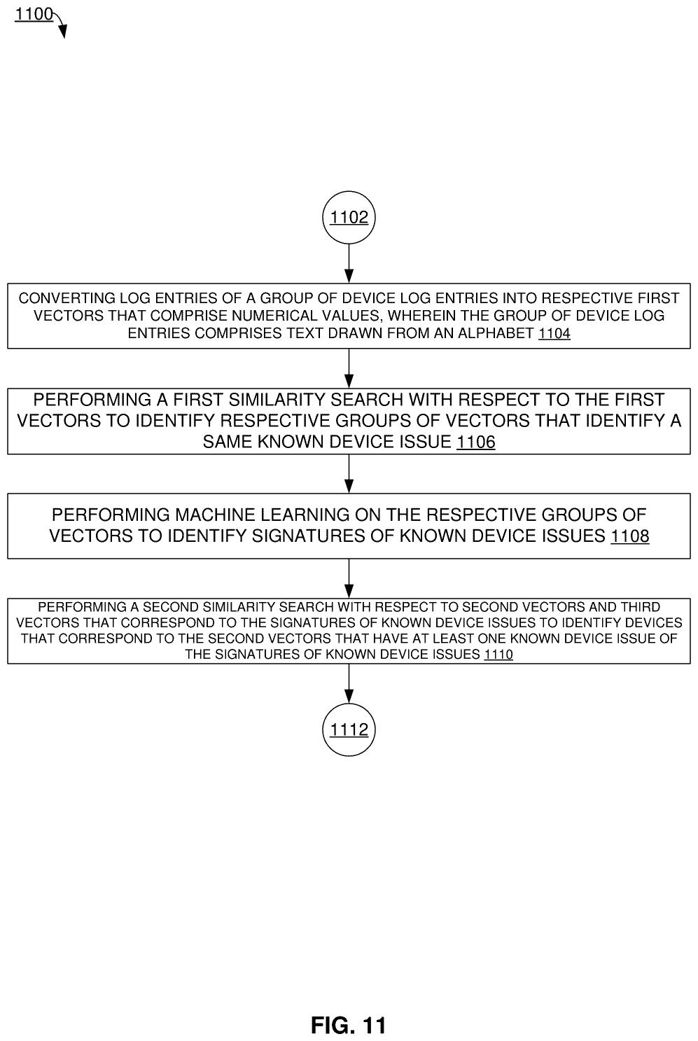

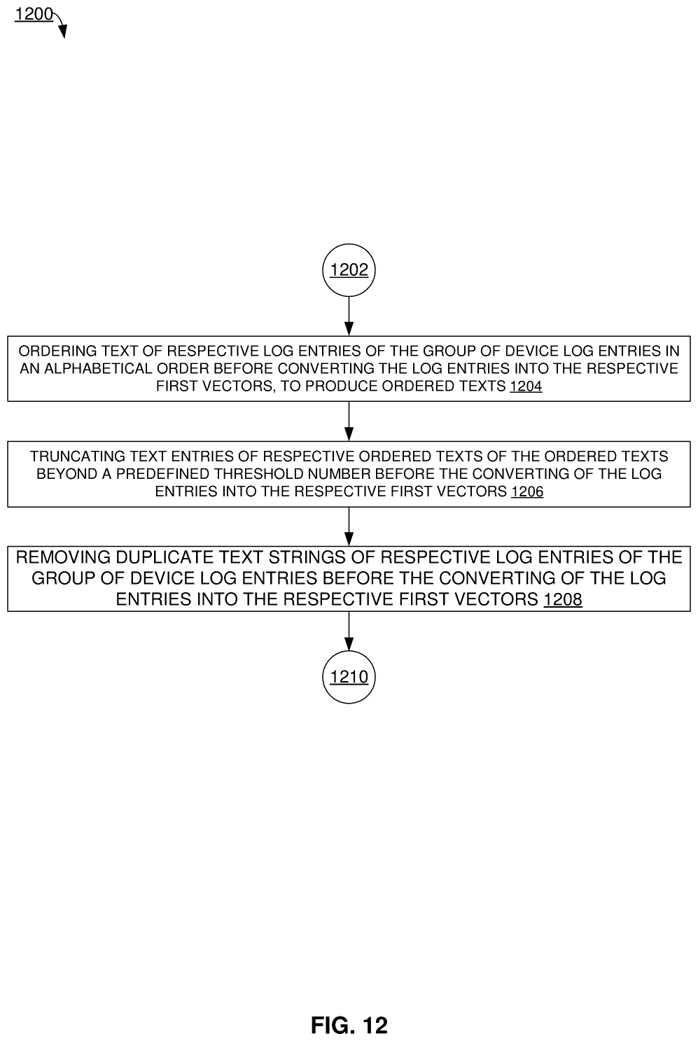

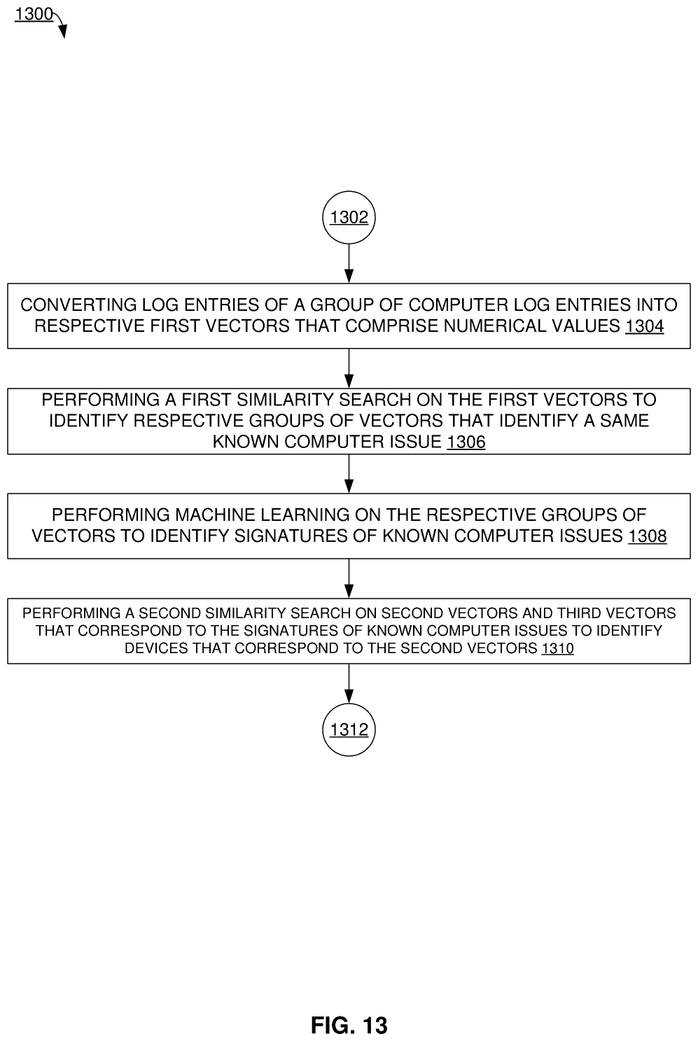

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 400 of FIG. 4, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 300 begins with 302, and moves to operation 304.

Operation 304 depicts linking customer issues to log data. That is, where an issue with a computer (e.g., one of monitored computers 106 of FIG. 1) is identified, corresponding log data for that computer can be identified.

After operation 304, process flow 300 moves to operation 306.

Operation 306 depicts extracting data representations from logs. That is, the log data from operation 304 can be processed to facilitate analyzing the processed data for issues.

After operation 306, process flow 300 moves to operation 308.

Operation 308 depicts detecting anomalies. This can comprise using a similarity search (among other techniques) to identify log data that corresponds to other log data for which anomalies have been previously identified.

After operation 308, process flow 300 moves to operation 310.

Operation 310 depicts associating anomalies with issues. That is, the anomalies detected in operation 308 can be associated with the issues in operation 304 so that the issues can be identified by the corresponding anomalous data. Then, fixes for the issues can be provided to the associated computers.

After operation 310, process flow 300 moves to 312, where process flow 300 ends.

FIG. 4 illustrates another example process flow 400 that can facilitate identifying unknown patterns in telemetry log data, in accordance with an embodiment of this disclosure. In some examples, one or more embodiments of process flow 400 can be implemented by identifying unknown patterns in telemetry log data component 108 of FIG. 1, or computing environment 1400 of FIG. 14.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 300 of FIG. 3, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 400 begins with 402, and moves to operation 404.

Operation 404 depicts vectorizing unique log events. That is, computer log files can be received as input, and transformed into vectors. Where one log event is represented multiple times, these multiple instances can be filtered out so that the resulting vectors uniquely represent one issue with one vector (rather than represent one issue with multiple vectors).

The log data can be in text form, and the resulting vector can store numbers—e.g., [0.2012, 0.0083, 0.079, . . . ]. An example of log data in text form for a driver log can be, “<Driver Type><Vendor><Version Number>,” where the version number can be a number (e.g., 9.0.36). An example of log data in text form for an application log can be, “<Vendor><Application Name>×64 Additional Runtime <Version Number>.”

In some examples, other processing can be performed in operation 404, such as by ordering the character strings (separated by a space within the log entry) alphabetically, and truncating a log entry after a fixed number of character strings (e.g., 128, and this can be done after alphabetizing the strings).

After operation 404, process flow 400 moves to operation 406.

Operation 406 depicts performing a similarity search to find similar vectors with same known issues. This similarity search can comprise graphing the vectors, or otherwise comparing them to find their Euclidean distance (which can represent a distance between two points in a graph). A higher similarity value can correspond to a lower Euclidean distance. There can be a threshold value for a Euclidean distance where, distances below this value indicate that the two corresponding vectors are similar, and distances above this value indicate that the two corresponding vectors are not similar.

In some examples, after performing a similarity search, the data can be filtered to the most meaningful logs. This can comprise filtering data based on their similarity search values, where multiple vectors that have highs similarity search values can be grouped together, and the vectors can collectively be grouped into multiple groups (where each group of vectors can represent computers that have a similar state).

After operation 406, process flow 400 moves to operation 408.

Operation 408 depicts performing machine learning to find known issue signatures in data. That is, a machine learning model can be trained (e.g., with labeled training data of vectors and labels that identify issues) to identify issues in vectors or the groups of vectors that from operation 406. This trained machine learning model can be used to process the vectors (or groups of vectors) from operation 406.

After operation 408, process flow 400 moves to operation 410.

Operation 410 depicts performing a similarity search to find similar vectors in fleet versus known issues. This can be a second similarity search relative to operation 406. In this similarity search, the known issues for vectors in operation 408 can be compared against new vectorized telemetry data. Where this newly vectorized telemetry data has a high similarity measurement against vectors with known data, then a corresponding computer can be determined to also have this known issue.

After operation 410, process flow 400 moves to 412, where process flow 400 ends.

### EXAMPLE GRAPHS

FIG. 5 illustrates example graphs 500 that can facilitate identifying unknown patterns in telemetry log data, in accordance with an embodiment of this disclosure. In some examples, part(s) of graphs 500 can be used by identifying unknown patterns in telemetry log data component 108 of FIG. 1 to facilitate identifying unknown patterns in telemetry log data.

Graphs 500 comprises graph 510 and graph 520. In turn, graph 510 comprises issues 502a and frequency 504a, and graph 520 comprises issues 502b and frequency 504b. Issues 502a and issues 502b can correspond to issues with computers (such as monitored computers 106 of FIG. 1). Frequency 504a and frequency 504b can correspond to a number of times that an issue is observed.

Graph 510 can correspond to issues in telemetry data before it is processed according to the present techniques (such as in operation 404 of FIG. 4). Graph 520 can correspond to issues in telemetry data after it is processed according to the present techniques (such as in operation 404 of FIG. 4).

FIG. 6 illustrates an example graph 600 that can facilitate identifying unknown patterns in telemetry log data, in accordance with an embodiment of this disclosure. In some examples, part(s) of graph 600 can be used by identifying unknown patterns in telemetry log data component 108 of FIG. 1 to facilitate identifying unknown patterns in telemetry log data.

Graph 600 comprises text source 602 and false positive count per query hit 604. That is, certain data sources can be determined to have more false positives than others. A purpose of this can be to determine which data sources have a high incidence of false positives, regardless of the issue being explored. Then, data sources with a high count of false positives can be removed from downstream machine learning activities.

### EXAMPLE TABLE

FIG. 7 illustrates an example table 700 that can facilitate identifying unknown patterns in telemetry log data, in accordance with an embodiment of this disclosure. In some examples, part(s) of table 700 can be used by identifying unknown patterns in telemetry log data component 108 of FIG. 1 to facilitate identifying unknown patterns in telemetry log data. Table 700 comprises issue 702, recall 704, and precision 706. Issue 702 can identify a particular issue.

Recall 704 and precision 706 can identify an ability of a trained machine learning model according to the present techniques to properly identify an issue. Recall 704 can identify a percentage of positives that are well-predicted by an example trained machine learning model according to the present techniques. That is, recall 704 can comprise ratio of a number of well predicted positives against the total number of positives (well-predicted positives and false negatives).

Precision 706 can identify a number of positive predictions that are well-made. That is, precision 706 can comprise a ratio of well-predicted positives against all positives predicted (well-predicted positives and false positives).

### EXAMPLE PROCESS FLOWS

FIG. 8 illustrates an example process flow 800 that can facilitate identifying unknown patterns in telemetry log data, in accordance with an embodiment of this disclosure. In some examples, one or more embodiments of process flow 800 can be implemented by identifying unknown patterns in telemetry log data component 108 of FIG. 1, or computing environment 1400 of FIG. 14.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 400 of FIG. 4, process flow 900 of FIG. 9, process flow 1000 of FIG. 10, process flow 1100 of FIG. 11, process flow 1200 of FIG. 12, and/or process flow 1300 of FIG. 13.

Process flow 800 begins with 802, and moves to operation 804.

Operation 804 depicts receiving a group of computer log entries that comprises letters in an alphabet. That is, using the example of FIG. 1, identifying unknown patterns in telemetry log data component 108 can receive log entries from monitored computers 106.

After operation 804, process flow 800 moves to operation 806.

Operation 806 depicts converting log entries of the group of computer log entries into respective first vectors that comprise numerical values. That is, the computer log entries of operation 804 can be vectorized. This can include transforming letters in computer log entries into numbers in the vectors.

In some examples, a first portion of the group of computer log entries comprises first text in a first language, and wherein a second portion of the group of computer log entries comprises second text in a second language. In some examples, a first vector of a first group of vectors of the groups of vectors corresponds to a first computer log entry of the group of computer log entries that comprises the first text in the first language, and wherein a second vector of the first group of vectors corresponds to a second computer log entry of the group of computer log entries that comprises the second text in the second language. That is, the present techniques can be applied to log entries that are represented in a variety of languages (e.g., applied to one group of log entries that have some individual entries in English and others in Chinese), and similar vectors can be found across the multiple languages (where the vectors represent data with numbers rather than with characters from a language).

After operation 806, process flow 800 moves to operation 808.

Operation 808 depicts performing a first similarity search with respect to the first vectors to identify respective groups of vectors that identify a same known computer issue. That is, a similarity search can be performed on the vectors of operation 806 to find vectors with the same known issues. This can result in grouping vectors that are determined to be similar.

In some examples, operation 808 comprises determining respective Euclidean distances between respective pairs of vectors of the first vectors. In some examples, operation 808 comprises determining respective dot products between respective pairs of vectors of the first vectors. That is, a similarity search can comprise determining a Euclidean distance between two vectors, and determining a Euclidean distance can comprise determining a dot product between the vectors.

After operation 808, process flow 800 moves to operation 810.

Operation 810 depicts performing machine learning on the respective groups of vectors to identify signatures of known computer issues. That is, machine learning can be performed on the output of operation 808 to find known signatures in the vectors.

After operation 810, process flow 800 moves to operation 812.

Operation 812 depicts performing a second similarity search with respect to second vectors and third vectors that correspond to the signatures of known computer issues to identify devices that correspond to the second vectors that have at least one known computer issue of the signatures of known computer issues. That is, another similarity search (in addition to the similarity search of operation 808) can be performed between the vectors with known signatures in operation 810 and vectors generated from new data (e.g., from monitored computers 106 of FIG. 1), so that issues can be identified for computers that correspond to this new data.

After operation 812, process flow 800 moves to operation 814.

Operation 814 depicts storing an indication of the devices. This can comprise storing the indication in computer storage of server 102 of FIG. 1.

After operation 814, process flow 800 moves to 816, where process flow 800 ends.

FIG. 9 illustrates an example process flow 900 that can facilitate identifying unknown patterns in telemetry log data, in accordance with an embodiment of this disclosure. In some examples, one or more embodiments of process flow 900 can be implemented by identifying unknown patterns in telemetry log data component 108 of FIG. 1, or computing environment 1400 of FIG. 14.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 400 of FIG. 4, process flow 800 of FIG. 8, process flow 1000 of FIG. 10, process flow 1100 of FIG. 11, process flow 1200 of FIG. 12, and/or process flow 1300 of FIG. 13.

Process flow 900 begins with 902, and moves to operation 904.

Operation 904 depicts identifying a second group of computer log entries, wherein the second group of computer log entries comprises a group of unique log entries of a first group of computer log entries. That is, from a group of computer log entries, duplicates can be removed to identify unique telemetry log events. In some examples, process flow 900 can be performed as part of operation 806 of FIG. 8.

After operation 904, process flow 900 moves to operation 906.

Operation 906 depicts converting log entries of the second group of computer log entries into respective first vectors. That is, unique telemetry log events can be vectorized as part of operation 806 of FIG. 8.

After operation 906, process flow 900 moves to 908, where process flow 900 ends.

FIG. 10 illustrates an example process flow 1000 that can facilitate identifying unknown patterns in telemetry log data, in accordance with an embodiment of this disclosure. In some examples, one or more embodiments of process flow 1000 can be implemented by identifying unknown patterns in telemetry log data component 1010 of FIG. 1, or computing environment 1400 of FIG. 14.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 300 of FIG. 3, process flow 400 of FIG. 4, process flow 800 of FIG. 8, process flow 900 of FIG. 9, process flow 1100 of FIG. 11, process flow 1200 of FIG. 12, and/or process flow 1300 of FIG. 13.

Process flow 1000 begins with 1002, and moves to operation 1004.

Operation 1004 depicts identifying second respective groups of vectors, wherein the second respective groups of vectors are drawn from first respective groups of vectors and satisfy a defined criterion of meaningfulness with respect to identifying any devices that have a first computer issue. That is, an output of operation 808 of FIG. 8 can be filtered so that a result of the similarity search is filtered to the most meaningful data.

After operation 1004, process flow 1000 moves to operation 1006.

Operation 1006 depicts performing machine learning on the second respective groups of vectors. That is, machine learning in operation 810 of FIG. 8 can be performed on vectors that have been filtered as in operation 1004.

After operation 1006, process flow 1000 moves to 1008, where process flow 1000 ends.

FIG. 11 illustrates an example process flow 1100 that can facilitate identifying unknown patterns in telemetry log data, in accordance with an embodiment of this disclosure. In some examples, one or more embodiments of process flow 1100 can be implemented by identifying unknown patterns in telemetry log data component 1111 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 300 of FIG. 3, process flow 400 of FIG. 4, process flow 800 of FIG. 8, process flow 900 of FIG. 9, process flow 1000 of FIG. 10, process flow 1200 of FIG. 12, and/or process flow 1300 of FIG. 13.

Process flow 1100 begins with 1102, and moves to operation 1104.

Operation 1104 depicts converting log entries of a group of device log entries into respective first vectors that comprise numerical values, wherein the group of device log entries comprises text drawn from an alphabet. In some examples, operation 1104 can be performed in a similar manner as operations 804-806 of FIG. 8.

In some examples, the group of device log entries comprises the text drawn from the alphabet and numbers. That is, log entries can comprise heterogenous data (e.g., both text and numerical values).

In some examples, the respective first vectors comprise respective one-dimensional vectors. In some examples, the respective first vectors have a predefined length. That is, the vectors can be 1×N dimensional vectors where N is a predefined value (e.g., 128).

After operation 1104, process flow 1100 moves to operation 1106.

Operation 1106 depicts performing a first similarity search with respect to the first vectors to identify respective groups of vectors that identify a same known device issue. In some examples, operation 1106 can be performed in a similar manner as operation 808 of FIG. 8.

After operation 1106, process flow 1100 moves to operation 1108.

Operation 1108 depicts performing machine learning on the respective groups of vectors to identify signatures of known device issues. In some examples, operation 1108 can be performed in a similar manner as operation 810 of FIG. 8.

After operation 1108, process flow 1100 moves to operation 1110.

Operation 1110 depicts performing a second similarity search with respect to second vectors and third vectors that correspond to the signatures of known device issues to identify devices that correspond to the second vectors that have at least one known device issue of the signatures of known device issues. In some examples, operation 1110 can be performed in a similar manner as operation 812 of FIG. 8.

After operation 1110, process flow 1100 moves to 1112, where process flow 1100 ends.

FIG. 12 illustrates an example process flow 1200 that can facilitate identifying unknown patterns in telemetry log data, in accordance with an embodiment of this disclosure. In some examples, one or more embodiments of process flow 1200 can be implemented by identifying unknown patterns in telemetry log data component 1212 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 300 of FIG. 3, process flow 400 of FIG. 4, process flow 800 of FIG. 8, process flow 900 of FIG. 9, process flow 1000 of FIG. 10, process flow 1100 of FIG. 11, and/or process flow 1300 of FIG. 13.

Process flow 1200 begins with 1202, and moves to operation 1204.

Operation 1204 depicts ordering text of respective log entries of the group of device log entries in an alphabetical order before converting the log entries into the respective first vectors, to produce ordered texts. In some examples, process flow 1200 can be implemented as part of operation 806 of FIG. 8 to process log entries before vectorizing them. Operation 1204 can comprise sorting text strings of a log entry in alphabetical order.

In some examples, the group of computer log entries comprises telemetry data, and wherein the telemetry data comprises pairs of time stamp values and log entry values. In some examples, the group of computer log entries is stored in documents that comprise human-readable text. That is, the telemetry data can be stored in a human-readable text format, such as a JavaScript Object Notation (JSON) format, or an Extensible Markup Language (XML) format.

After operation 1204, process flow 1200 moves to operation 1206.

Operation 1206 depicts truncating text entries of respective ordered texts of the ordered texts beyond a predefined threshold number before the converting of the log entries into the respective first vectors. That is, vectors can have a fixed length, so a log entry can be truncated at a certain number of words that matches this fixed length (e.g., 128). This can be performed after sorting words in a log entry alphabetically.

After operation 1206, process flow 1200 moves to operation 1208.

Operation 1208 depicts removing duplicate text strings of respective log entries of the group of device log entries before the converting of the log entries into the respective first vectors. That is, where there are duplicate log entries, the duplicates can be removed to leave one log entry from the group. It can be that one log entry among a group of duplicate entries is sufficient to identify an issue, so removing duplicates can conserve processing resources.

After operation 1208, process flow 1200 moves to 1210, where process flow 1200 ends.

FIG. 13 illustrates an example process flow 1300 that can facilitate identifying unknown patterns in telemetry log data, in accordance with an embodiment of this disclosure. In some examples, one or more embodiments of process flow 1300 can be implemented by identifying unknown patterns in telemetry log data component 1313 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 300 of FIG. 3, process flow 400 of FIG. 4, process flow 800 of FIG. 8, process flow 900 of FIG. 9, process flow 1000 of FIG. 10, process flow 1100 of FIG. 11, and/or process flow 1200 of FIG. 12.

Process flow 1300 begins with 1302, and moves to operation 1304.

Operation 1304 depicts converting log entries of a group of computer log entries into respective first vectors that comprise numerical values. In some examples, operation 1304 can be performed in a similar manner as operations 804-806 of FIG. 8.

In some examples, the group of computer log entries is categorized in a group of tables that corresponds to device components. In some examples, the processor is a first processor, wherein a first table of the group of tables corresponds to a second processor of the device components, wherein a second table of the group of tables corresponds to a storage drive of the device components, and wherein a third table of the group of tables corresponds to memory tables of the device components. That is, in some examples, log entries can be categorized and stored in tables at the component level (e.g., separate tables for CPU data, hard drive data, and memory data).

In some examples, the group of computer log entries comprises telemetry data, and wherein the telemetry data comprises pairs of time stamp values and log entry values. In some examples, the group of computer log entries is stored in documents that comprise human-readable text. That is, the telemetry data can be stored in a human-readable text format, such as a JavaScript Object Notation (JSON) format, or an Extensible Markup Language (XML) format.

After operation 1304, process flow 1300 moves to operation 1306.

Operation 1306 depicts performing a first similarity search on the first vectors to identify respective groups of vectors that identify a same known computer issue. In some examples, operation 1306 can be performed in a similar manner as operation 808 of FIG. 8.

After operation 1306, process flow 1300 moves to operation 1308.

Operation 1308 depicts performing machine learning on the respective groups of vectors to identify signatures of known computer issues. In some examples, operation 1308 can be performed in a similar manner as operation 810 of FIG. 8.

After operation 1308, process flow 1300 moves to operation 1310.

Operation 1310 depicts performing a second similarity search on second vectors and third vectors that correspond to the signatures of known computer issues to identify devices that correspond to the second vectors. In some examples, operation 1310 can be performed in a similar manner as operation 812 of FIG. 8.

In some examples, operation 1310 comprises determining a remedial action for a first device of the devices. That is, once an issue for a computer has been identified, then a corresponding fix (e.g., a software patch) can be identified and then implemented for the computer to resolve or mitigate the issue.

After operation 1310, process flow 1300 moves to 1312, where process flow 1300 ends.

### EXAMPLE OPERATING ENVIRONMENT

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of server 102 and/or monitored computers 106 of FIG. 1.

In some examples, computing environment 1400 can implement one or more embodiments of the process flows of FIGS. 3-4 and/or 8-13 to facilitate identifying unknown patterns in telemetry log data.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory coupled to the processor, comprising instructions that cause the processor to perform operations comprising:
receiving a group of computer log entries that comprises letters in an alphabet;
converting log entries of the group of computer log entries into respective first vectors that comprise numerical values;
performing a first similarity search with respect to the first vectors to identify respective groups of vectors that identify a same known computer issue;
performing machine learning on the respective groups of vectors to identify signatures of known computer issues;
performing a second similarity search with respect to second vectors and third vectors that correspond to the signatures of known computer issues to identify devices that correspond to the second vectors that have at least one known computer issue of the signatures of known computer issues; and
storing an indication of the devices.

2. The system of claim 1, wherein the group of computer log entries is a first group of computer log entries, and wherein the operations further comprise:
identifying a second group of computer log entries, wherein the second group of computer log entries comprises a group of unique log entries of the first group of computer log entries, and wherein the converting of the log entries of the first group of computer log entries into the respective first vectors is performed on the second group of computer log entries.

3. The system of claim 1, wherein the respective groups of vectors are first respective groups of vectors, and wherein the operations further comprise:
identifying second respective groups of vectors, wherein the second respective groups of vectors are drawn from the first respective groups of vectors and satisfy a defined criterion of meaningfulness with respect to identifying any devices that have a first computer issue, and wherein the performing the machine learning is performed on the second respective groups of vectors.

4. The system of claim 1, wherein performing the first similarity search with respect to the first vectors to identify the respective groups of vectors that identify the same known computer issue comprises:
determining respective Euclidean distances between respective pairs of vectors of the first vectors.

5. The system of claim 1, wherein performing the first similarity search with respect to the first vectors to identify the respective groups of vectors that identify the same known computer issue comprises:
determining respective dot products between respective pairs of vectors of the first vectors.

6. The system of claim 1, wherein a first portion of the group of computer log entries comprises first text in a first language, and wherein a second portion of the group of computer log entries comprises second text in a second language.

7. The system of claim 6, wherein a first vector of a first group of vectors of the groups of vectors corresponds to a first computer log entry of the group of computer log entries that comprises the first text in the first language, and wherein a second vector of the first group of vectors corresponds to a second computer log entry of the group of computer log entries that comprises the second text in the second language.

8. A method, comprising:
converting, by a system comprising a processor, log entries of a group of device log entries into respective first vectors that comprise numerical values, wherein the group of device log entries comprises text drawn from an alphabet;
performing, by the system, a first similarity search with respect to the first vectors to identify respective groups of vectors that identify a same known device issue;
performing, by the system, machine learning on the respective groups of vectors to identify signatures of known device issues; and
performing, by the system, a second similarity search with respect to second vectors and third vectors that correspond to the signatures of known device issues to identify devices that correspond to the second vectors that have at least one known device issue of the signatures of known device issues.

9. The method of claim 8, further comprising:
ordering, by the system, text of respective log entries of the group of device log entries in an alphabetical order before converting the log entries into the respective first vectors.

10. The method of claim 9, wherein ordering the text of the respective log entries produces ordered texts, and further comprising:
truncating, by the system, text entries of respective ordered texts of the ordered texts beyond a predefined threshold number before the converting of the log entries into the respective first vectors.

11. The method of claim 8, further comprising:
removing, by the system, duplicate text strings of respective log entries of the group of device log entries before the converting of the log entries into the respective first vectors.

12. The method of claim 8, wherein the group of device log entries comprises the text drawn from the alphabet and numbers.

13. The method of claim 8, wherein the respective first vectors comprise respective one-dimensional vectors.

14. The method of claim 8, wherein the respective first vectors have a predefined length.

15. A non-transitory computer-readable medium comprising instructions that, in response to execution, cause a system comprising a processor to perform operations, comprising:
converting log entries of a group of computer log entries into respective first vectors that comprise numerical values;
performing a first similarity search on the first vectors to identify respective groups of vectors that identify a same known computer issue;
performing machine learning on the respective groups of vectors to identify signatures of known computer issues; and
performing a second similarity search on second vectors and third vectors that correspond to the signatures of known computer issues to identify devices that correspond to the second vectors.

16. The non-transitory computer-readable medium of claim 15, wherein the group of computer log entries is categorized in a group of tables that corresponds to device components.

17. The non-transitory computer-readable medium of claim 16, wherein the processor is a first processor, wherein a first table of the group of tables corresponds to a second processor of the device components, wherein a second table of the group of tables corresponds to a storage drive of the device components, and wherein a third table of the group of tables corresponds to memory tables of the device components.

18. The non-transitory computer-readable medium of claim 15, wherein the group of computer log entries comprises telemetry data, and wherein the telemetry data comprises pairs of time stamp values and log entry values.

19. The non-transitory computer-readable medium of claim 15, wherein the group of computer log entries is stored in documents that comprise human-readable text.

20. The non-transitory computer-readable medium of claim 15, wherein the operations further comprise:
determining a remedial action for a first device of the devices.
